(19) United States
(12) Patent Application Publication
(10) Pub. No.: US 2006/0204137 A1
(43) Pub. Date: Sep. 14, 2006

(54) Portable terminal and information-processing device, and system

(75) Inventors: Shinichi Shimoda, Yokohama (JP); Tamotsu Ito, Ayase (JP)

Correspondence Address: MCDERMOTT WILL & EMERY LLP, 600 13TH STREET, N.W., WASHINGTON, DC, 20005-3096, US

(73) Assignee: Hitachi, Ltd.

(21) Appl. No.: 11/239,102

(22) Filed: Sep. 30, 2005

(30) Foreign Application Priority Data
Mar. 7, 2005 (JP) 2005-061791

(51) Int. Cl. G06K 9/32; G09G 5/00

(52) U.S. Cl. 382/298; 345/660

(57) ABSTRACT

The portable terminal of the present invention has an imaging unit and produces a background picture and an object picture by using the pictures of a room etc. and an object to be placed in the room outputted from the imaging unit. Then, the portable terminal combines the background and object pictures into a simulation picture, determines whether or not the object can be placed in a space designated by a user, and notifies the user of the result.

This application claims the benefit of priority of Japanese Application No. 2005-061791 filed Mar. 7, 2005, the disclosure of which also is entirely incorporated herein by reference.

### TECHNICAL FIELD

The present invention relates to a portable terminal capable of displaying picture information and an information-processing device, and an information-processing system.

### BACKGROUND

Disclosed in Japanese Patent Laid-open No. 2003-337900 is a system which enable a user to handle the three-dimensional floor plan of a house which he or she purchased and the three-dimensional dimensions of products of shops of furniture and household electric utensils on the Web and simulate the arrangement of furniture and electric utensils fitting the floor plan. Disclosed in Japanese Patent Laid-open No. 2003-256876 is a method of presenting a virtual world wherein the outside appearances, such as sizes and colors, of actual objects are harmonized with the environment by arranging object-teaching, or instructing, indices instead of actual objects.

If one purchases a house of a certain type from a housing developer, one may be able to obtain the floor plan of the house. However, if we have our houses built individually and separately in accordance with our respective tastes and needs, we can rarely obtain the floor plans of our respective houses. Besides, the three-dimensional data of all furniture and household electric utensils are not always available. Accordingly, the above system is usable in some cases and not usable in other cases. In the case of the above method, one cannot judge, on the spot, whether the piece of furniture fits one's room or not even if one finds a piece of furniture of one's taste. One has to bring the object-teaching index to one's house to see whether the piece of furniture fits one's room or not. Besides, like in the case of the floor plan, the object-teaching indices of all objects are not always available.

Moreover, it may be difficult for one to judge whether the size of an object fits one's room or not by merely looking at a simulation picture. For example, one may wish to place an object in a certain space of a room, but one may not be able to see whether or not the object is placed in the space without interfering with other objects and walls. If the screen of one's portable terminal is small, it may be difficult for one to judge by merely looking at a picture on the screen.

### SUMMARY

The present invention has been made in view of the above circumstances and provides a portable terminal that has an imaging unit, and that produces a background picture and an object picture by using the pictures of a room and an object to be placed in the room outputted from the imaging unit, combines the background and object pictures into a simulation picture, determines whether or not the object can be placed in a space designated by the user, and notifies the user of the result.

In one aspect of the invention, the information-processing device has a first choosing unit to choose a space wherein an object is supposed to be placed, a first size-acquiring unit to acquire the first size information showing the size of the space, a second choosing unit to choose an object to be placed in the space, a second size-acquiring unit to acquire the second size information showing the size of the object, and a notifying unit to determine whether the object can be placed in the space or not and notify the user of the result.

### BRIEF DESCRIPTION OF THE DRAWINGS

Embodiments of the present invention will be described in detail based on the following figures, wherein:

FIG. 1 shows an example of the components of a portable terminal according to an embodiment of the present invention;

FIG. 2 is a schematic illustration of how to display a simulation picture on the screen of the portable terminal of FIG. 1;

FIG. 3 is an example of pictures on the screen of the portable terminal of FIG. 1;

FIG. 4 is a flowchart of the procedure for the portable terminal of FIG. 1 to obtain a background picture and an object picture;

FIG. 5 is another example of pictures on the screen of the portable terminal of FIG. 1;

FIG. 6 is an illustration of the concept of how to designate a space wherein an object is to be placed;

FIG. 7 is an illustration of the concept of how to measure a distance with a gradient sensor;

FIG. 8 is an illustration of data stored in the portable terminal of FIG. 1;

FIG. 9 is still another example of pictures on the screen of the portable terminal of FIG. 1;

FIG. 10 is an illustration of the concept of how to obtain an object picture;

FIG. 11 is a flowchart of the procedure for the portable terminal of FIG. 1 to display a simulation picture;

FIG. 12 is a further example of pictures on the screen of the portable terminal of FIG. 1;

FIG. 13 is a still further example of pictures on the screen of the portable terminal of FIG. 1;

FIG. 14 is a flowchart of the procedure for the portable terminal of FIG. 1 to determine whether an object can be placed in a space or not;

FIG. 15 is another example of pictures on the screen of the portable terminal of FIG. 1;

FIG. 16 is still another example of pictures on the screen of the portable terminal of FIG. 1;

FIG. 17 is a further example of pictures on the screen of the portable terminal of FIG. 1; and

FIG. 18 is an illustration of a system for producing simulation pictures according to an embodiment of the present invention.

### DETAILED DESCRIPTION

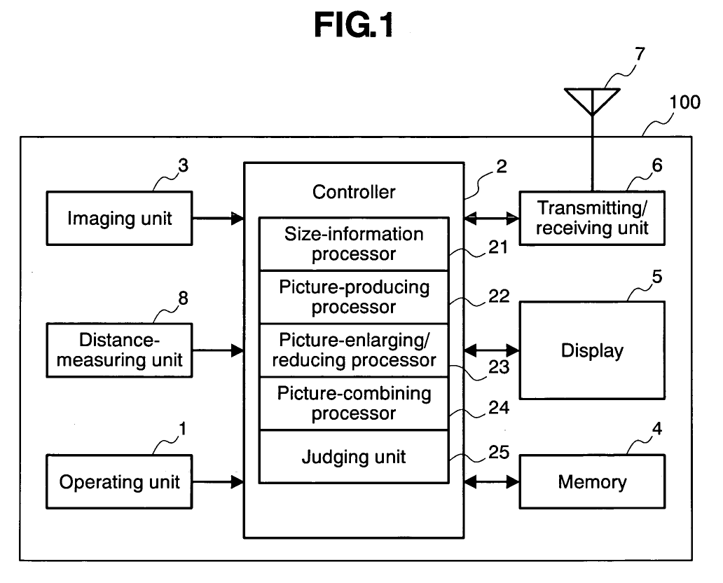

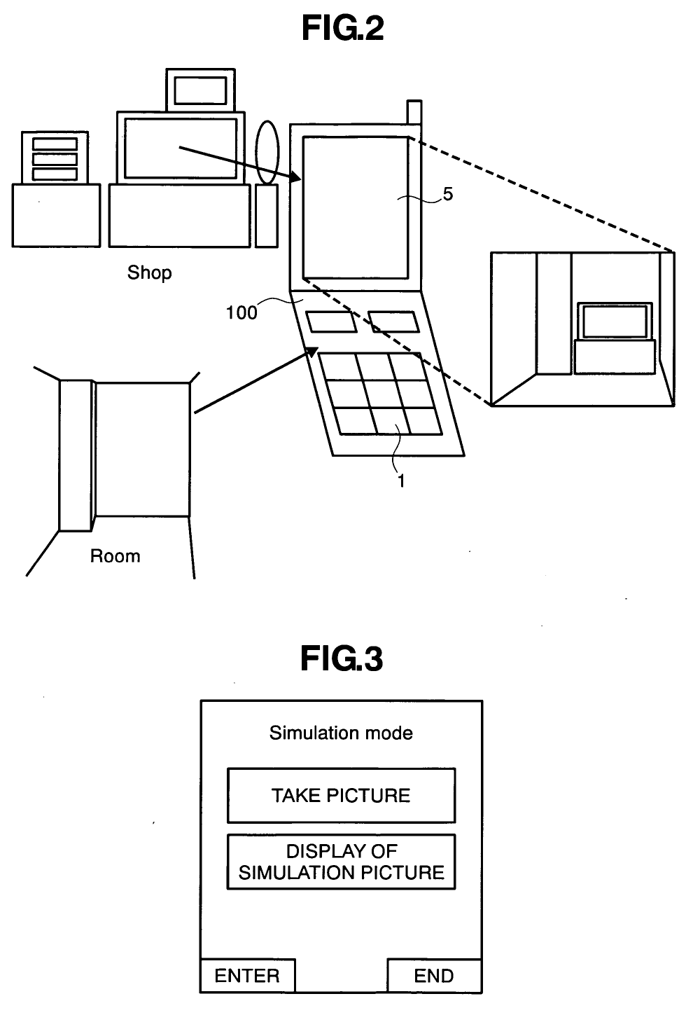

FIG. 1 shows an example of the components of an embodiment of a portable terminal 100 of the present invention. The portable terminal 100 is a portable telephone, a personal digital assistant (PDA), or the like. The reference numeral 1 is an operating unit, which is a key-operating unit, a touch panel, a voice-inputting unit for the user to input instructions with voice, or the like. The user inputs instructions, data, etc. by operating the operating unit 1. The reference numeral 2 is a controller, which includes processing devices such as a central processing unit (CPU) and controls the other units of the portable terminal 100 in accordance with the instructions inputted through the operating unit 1 and a program stored in a memory 4. The controller 2 includes a size-information processor 21, a picture-producing processor 22, a picture-enlarging/reducing processor 23, a picture-combining processor 24, and a judging unit 25. These processors and unit 21 to 25 may be provided separately from the controller 2.

The reference numeral 3 is an imaging unit, which may be a camera. The imaging unit 3 takes pictures and outputs the information about the pictures. The memory 4 is a data storage, such as a memory IC or a hard-disk drive, to store data. The memory 4 is not limited to the one built in the portable terminal 100 and it may be a memory card which can be inserted in and detached from the portable terminal 100 or an external storage connected to the portable terminal 100 from the outside. The reference numeral 5 is a display, which may be a liquid-crystal display etc. for displaying pictures and letters, or characters. The reference numeral 6 is a transmitting and receiving unit to communicate with external base stations and other devices through an antenna 7. The reference numeral 8 is a distance-measuring unit, which measures the distance from the photo-taking point to an object whose picture is to be taken by the imaging unit 3. The distance-measuring unit 8 is an auto-focusing sensor or the like.

Describe below is a method of first taking a picture of the user's room as a background picture, storing the background picture in the memory 4 of the portable terminal 100, taking its picture when the user finds a piece of furniture or a household electric utensil of his or her taste in a shop, combining the two pictures into a simulation picture (virtual picture), and displaying the simulation picture on the screen of the display 5 of the portable terminal 100. The pictures of furniture and household electric utensils to be combined with background pictures are hereinafter called “object pictures.” In the following example, a room is shown as a prescribed space where an object is placed. However, background pictures are not limited to this and they may be outdoor pictures instead of room pictures.

When the user operates the operating unit 1 and chooses the start of the simulation mode, the controller 2 starts a program to execute the simulation mode. The program may be stored in the memory 4 in advance, or the user may install the program after purchasing the portable terminal 110. When the simulation mode is started, the picture shown in FIG. 3, for example, is displayed on the display 5.

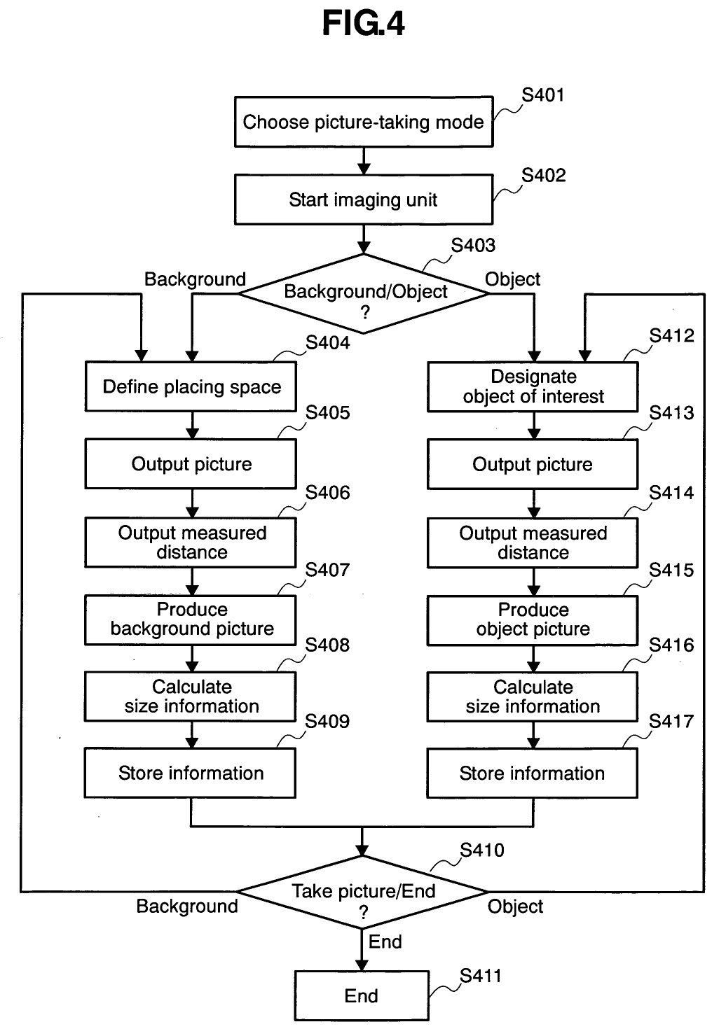

By referring to the flowchart of FIG. 4, the method of acquiring a background picture and an object picture will first be described. When the user chooses the picture-taking mode (S401), the imaging unit 3 is started (S402) and the picture of FIG. 5 is displayed on the display 5, prompting the user to choose either “BACKGROUND” or “OBJECT” (S403).

If “BACKGROUND” is chosen, a through picture of a room and a reference mark are displayed on the display 5. The reference mark is a mark which serves as a reference point to bring the imaging unit 3 into focus. The user operates the portable terminal 100 to bring the reference mark to the reference point for the placement of a piece of furniture in the room. If the user wishes to place a piece of furniture between points A and B, the user operates the operating unit 1 to move the reference mark up and down, right and left and position the reference mark (S404). Each time the reference mark is positioned, the imaging unit 3 outputs a picture (S405).

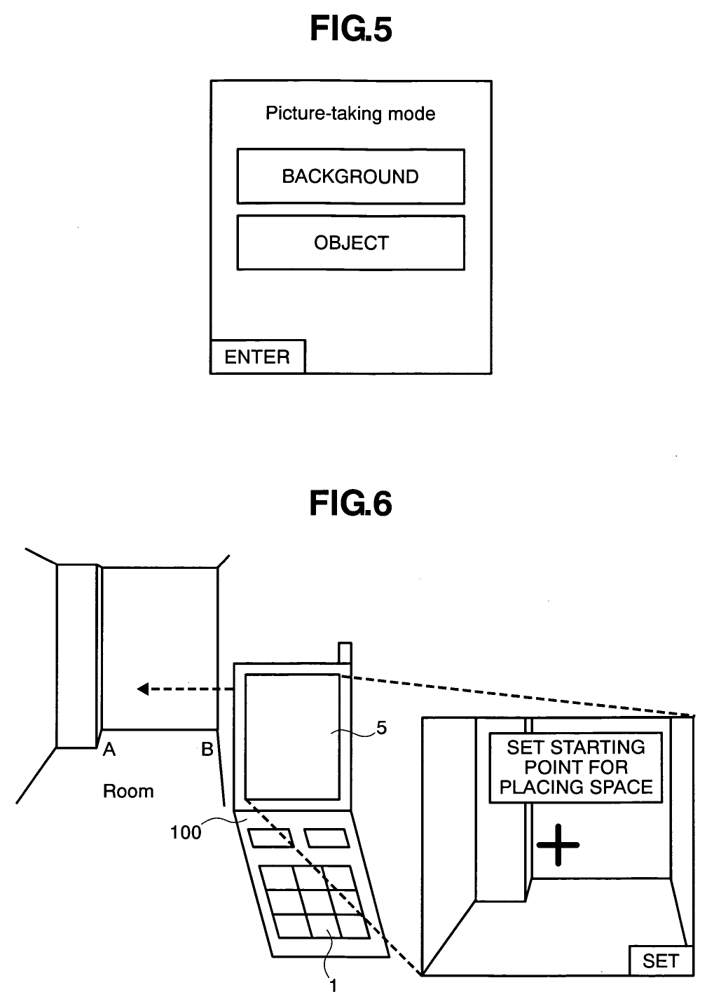

The reference mark may be fixed at the center of the screen and the portable terminal 100 may be moved to bring the reference mark to the intended position. In the case of the example shown in FIG. 6, the width of a space for placement, or placing space, is defined, but the height of a placing space or both the width and height of a placing space may be defined.

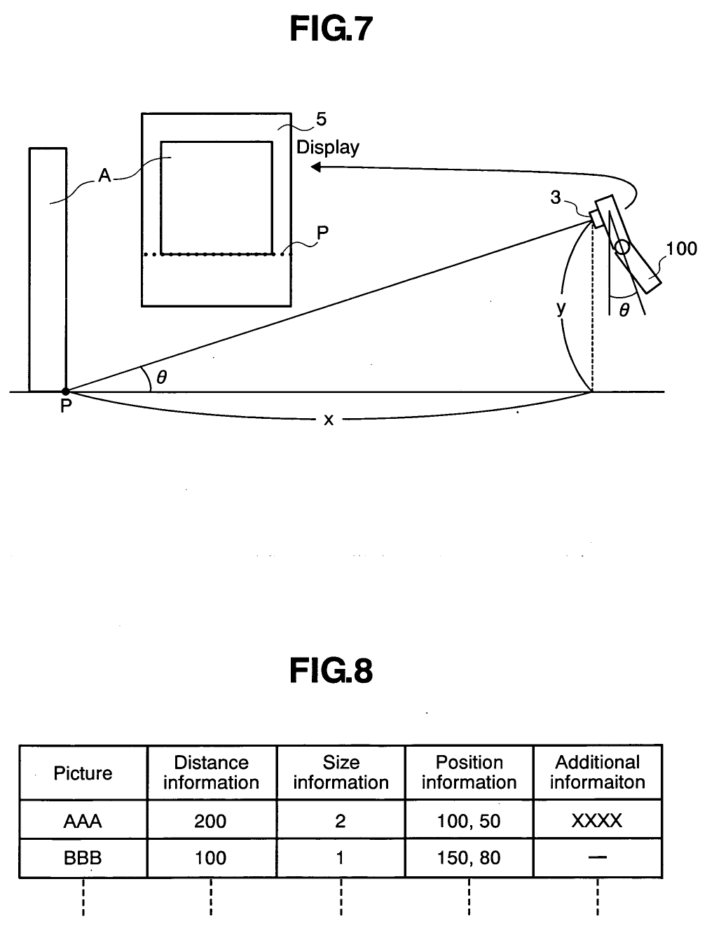

The distance-measuring unit 8 measures and outputs the distance from the photo-taking point to the point of the reference mark (S406). The distance-measuring unit 8 is an auto-focusing sensor or the like as mentioned earlier, but the distance may be measured by equipping the imaging unit 3 with two cameras or taking more than one picture at different photo-taking points and using the principle of triangulation. Besides, the distance may be measured by using an ultrasonic sensor, an infrared sensor, or the like. Moreover, the distance may be measured by placing a reference scale and taking a picture. Furthermore, the distance may be measured with the portable terminal 100 with a gradient sensor as shown in FIG. 7. The distance x to an object “A” is given by the expression of x=y/tan θ. The height of shoulders of the user or the like may be inputted as the height y in advance. Because the angle θ is equal to the inclination of the portable terminal 100, the gradient sensor of the portable terminal 100 detects the angle θ when the user brings the broken line P on the screen of the display 5 to the bottom side of the object “A”.

If the distance-measuring unit 8 is an auto-focusing sensor, it serves as a focusing unit for ordinary photo-taking, too; accordingly, it is unnecessary to equip the portable terminal 100 with a distance-measuring device in particular. Thus, the manufacturing cost of the portable terminal 100 is kept low.

The picture-producing processor 22 combines two pictures outputted from the imaging unit 3 into a background picture (S407) Alternatively, the imaging unit 3 may combine two pictures into a background picture and output the background picture.

The size-information processor 21 uses the information about distance outputted from the distance-measuring unit 8 and determines the size of the placing space based on the number of pixels occupied by the placing space in the background picture (S408). If one takes a picture of an object one centimeter long at a distance of one meter, the object in the picture is one pixel long. This distance-length relation is inputted into the memory 4. If the width of an object whose picture has been taken at the distance of one meter is 50 pixels in the picture, its width is found to be 50 cm by the controller 2. Besides, as the width of an object is in inverse proportion to the distance from the photo-taking point to the object, the controller 2 can calculate the size of the object even if the distance changes. If the distance is two meters, one pixel is equivalent to two centimeters. If the camera has the function of zooming in and out, the distance-size relation collapses. Nevertheless, as the magnification is known, the size of the object can be calculated by taking the magnification into account.

The information about the photo-taking distance measured by the distance-measuring unit 8 and the information about the size of the placing space calculated by the size-information processor 21, together with the background picture, are stored into the memory 4 of the portable terminal 100 (S409).

FIG. 8 is an illustration of the data stored in the memory 4. Information about distances and sizes are linked to information about pictures and all the information is stored in the memory 4. In the present embodiment, the data on coordinates of the reference point for the measurement of distance are stored as information about positions into the memory 4. Because the reference point for the measurement of distance is the place where the user intends to situate a piece of furniture or the like, the picture of the object can easily be displayed at the place by storing the coordinates of the place into the memory 4.

Other information than information about pictures, distances, etc. may be stored as additional information into the memory 4. For example, if the portable terminal 100 is equipped with a detector of brightness such as a photo-sensor, the data on the brightness at the time of photo-taking may be stored as additional information into the memory 4. If there is a significant difference between the brightness at the time of taking pictures of a room and that at the time of taking a picture of a piece of furniture, their simulation picture may differ in color and atmosphere from their real scene. If the data on brightness, together with the data on pictures, are stored into the memory 4, their brightness can be adjusted when the picture of an object is combined with the picture of a room to produce a simulation picture which is close to the real scene of the object placed in the room.

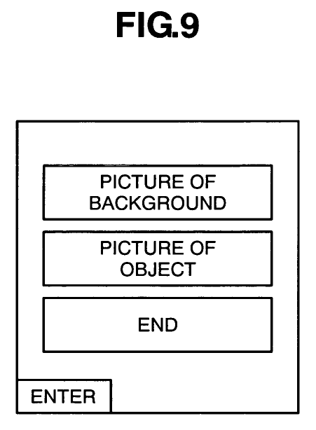

After the storage of the background picture etc., the picture of FIG. 9, for example, is displayed on the screen of the display 5 to prompt the user to choose one of “PICTURE OF BACKGROUND,” “PICTURE OF OBJECT,” or “END” (S410). Prompting the user in this way helps the user to shift smoothly to the acquisition of another background picture or an object picture. When “END” is chosen, the simulation mode may be ended or the picture of FIG. 3 may be displayed again. If the picture of FIG. 3 is displayed again, the user can choose “DISPLAY OF SIMULATION PICTURE.” Thus, the convenience of the portable terminal 100 can be raised.

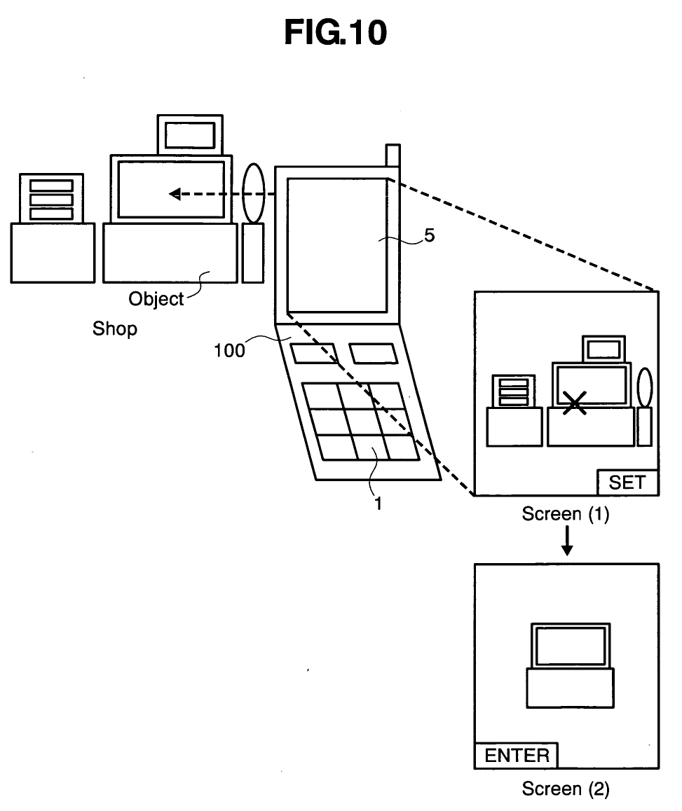

If “(PICTURE OF) OBJECT” is chosen in S403 or S410 at a shop, a through picture of the shop and a reference mark are displayed on the screen of the display 5 as shown in FIG. 10. The through picture often contains objects of no interest as well as the object of interest. In this case, the user operates the portable terminal 100 to bring the reference mark onto the object of interest (S412). When the user chooses the button “SET,” the imaging unit 3 outputs a picture containing the object of interest (S413) and the distance-measuring unit 8 outputs the distance to the object of interest (S414). The picture-producing processor 22 extracts the object of interest and produces an object picture (S415). The picture-producing processor 22 extracts the object of interest by, for example, the difference in color between the object of interest and the other objects. Alternatively, the user may draw the contour of the object of interest by maneuvering the cursor or the like on the screen, or the display 5 may be of a touch-panel type and the user may draw the contour of the object of interest on the screen with his finger, a pen, or the like. If the portable terminal 100 is equipped with a stereo camera, the object of interest may be extracted from a plurality of pictures.

The size-information processor 21 calculates the size of the object from the distance to the object and the number of pixels of the object on the screen (S416). The information about the size of the object, together with the object picture, is stored in the memory 4 (S417).

At this time, other information than the object picture and information about the size of the object may be stored as additional information into the memory 4. If the object of interest has doors and drawers and the shape of the object changes when its doors and drawers are opened, information that the shape of the object changes when its doors and drawers are opened and information about the size of the object with its doors and drawers opened may be stored as additional information into the memory 4. The information about the size of the object with its doors and drawers opened may be acquired by taking a picture of the object with its doors and drawers opened or by choosing the opening or closing of its doors and drawers and estimating the size of the object. For example, there is provided a menu containing items such as doors, drawers, opened fully, opened halfway, closed fully, and closed halfway and the size of the object is calculated in accordance with the user's choice. For example, if the user chooses “doors” and “opened fully,” the value twice the width of the object is stored into the memory 4.

It is assumed in the above explanation that the imaging unit 3 takes static pictures of objects and their backgrounds, but the imaging unit 3 may take dynamic images, a plurality of static pictures may be extracted from the dynamic images, and information about distances and sizes may be acquired from the static pictures.

In the above explanation, object and background pictures are produced from pictures taken by the imaging unit 3 and stored into the memory 4, but the portable terminal 100 may receive information about pictures, sizes, etc. of furniture and household electric utensils through its transmitting and receiving unit 6 connected to a network such as the Internet. Besides, information may be acquired in a shop or the like through a wireless LAN and infrared communication. If the portable terminal 100 is supposed to receive three-dimensional data on furniture etc., it is necessary to equip the portable terminal 100 with a processor to process the three-dimensional data into two-dimensional data in order to display two-dimensional pictures on the screen of the display 5.

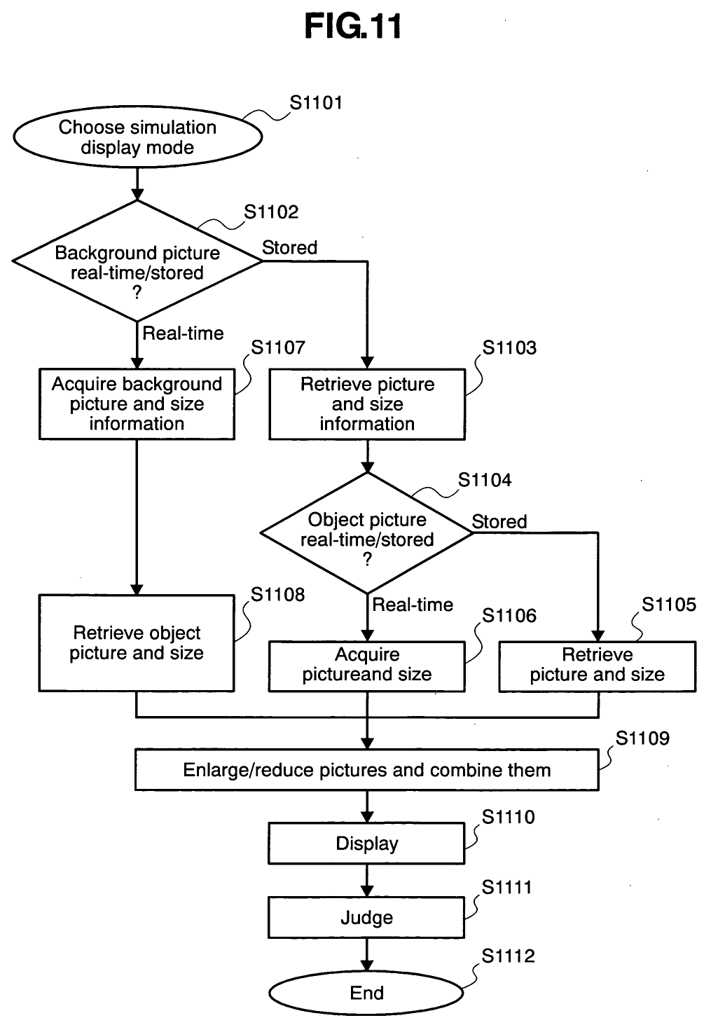

By referring to the flowchart of FIG. 11, the processing for the display of a simulation picture will be described below. When the user chooses “DISPLAY OF SIMULATION PICTURE” in the picture of FIG. 3 (S1101), displayed on the screen of the display 5 is a message prompting the user to choose the use of a real-time background picture taken on the spot or the use of one of the background pictures stored in the memory 4 (S1102). If the use of one of the background pictures stored in the memory 4 is chosen, the table of the background pictures stored in the memory 4 is displayed on the screen of the display 5. When the user chooses one of the background pictures, the information about the background picture and its size are retrieved (S1103). Then, the user is prompted to choose the use of a real-time object picture or the use of one of the object pictures stored in the memory 4 (S1104). If the user chooses the use of one of the object pictures stored in the memory 4, the table of the object pictures stored in the memory 4 is displayed on the screen of the display 5 and the object picture chosen by the user is retrieved (S1105). If the user chooses a real-time object picture, the imaging unit 3 is started, a picture of the object designated by the user is taken, and information about the size of the object is outputted (S1106).

If the user chooses the use of a real-time background picture, the imaging unit 3 is started and a background picture of the placing space designated by the user and information about the size of the placing space are produced (S1107). If the user chooses the use of a real-time background picture, the table of the object pictures stored in the memory 4 is automatically displayed on the screen of the display 5 and the object picture chosen by the user is retrieved (S1108).

As described above, the user can use any of the object and background pictures stored in the memory 4 and real-time object and background pictures taken on the spot; thus, the user can use various combinations of pictures in accordance with various situations. The order of choice of a background picture and an object picture shown by the flowchart of FIG. 11 may be reversed.

Next, the picture-enlarging/reducing processor 23 processes the chosen object and background pictures by using the information about their sizes to make the relative sizes of the object and the background even, and the picture-combining processor 24 combines the object and background pictures into a simulation picture (S1109). Then, the simulation picture is displayed on the screen of the display 5 (S1110). If information about the position of the reference mark is stored into the memory 4 at the time of storage of information about a background picture, the picture-combining processor 24 combines the object and background pictures based on the information about the position of the reference mark. If one of the object pictures stored in the memory 4 is used, it is desirable for the user to be able to adjust the place of display of the object picture by operating the operating unit 1.

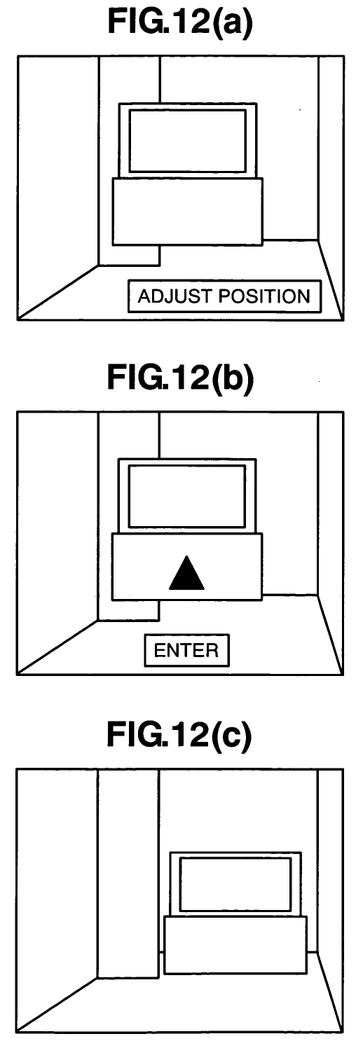

By referring to FIG. 12, a method of adjusting the place of display of an object picture retrieved from the memory 4 will be described below. FIG. 12(a) is an example of simulation pictures. When the user operates the operating unit 1 to choose the button “ADJUST POSITION,” a cursor appears on the screen of the display 5 as shown in FIG. 12 (b). The user operates the operating unit 1 to move the cursor and, hence, the object picture to any position as shown in FIG. 12 (c).

As described above, the user can see a simulation picture wherein an object found by him or her in a shop is placed in the user's room. Thus, the user can see on the spot whether an object found by him or her in a shop is too large for the room or not and whether it matches the room or not. Besides, the portable terminal 100 of the present embodiment is capable of using pictures taken by the imaging unit 3 and displaying a simulation picture; therefore, even if data such as a floor plan is not available, the user can easily see a simulation picture.

Moreover, the size of an object such as a piece of furniture and the size of a room, together with their simulation pictures, may be displayed. In this case, the user can ascertain the adaptability of the object to the room not only visually but also numerically.

If information about brightness, together with information about pictures, is stored in the memory 4, the brightness of an object picture and a background picture may be adjusted before combining them into a simulation picture. If a background picture is darker than an object picture, the brightness of the object picture may be reduced to the average brightness level of the background picture. By adjusting the brightness of an object picture to balance it with the brightness of a background picture in this way, simulation that is more real can be made. The brightness of an object picture doesn't necessarily have to be adjusted to balance it to the brightness of a background picture. If either a background picture or an object picture is a real-time picture, the brightness of the non-real-time picture may be adjusted to the brightness level of the real-time one.

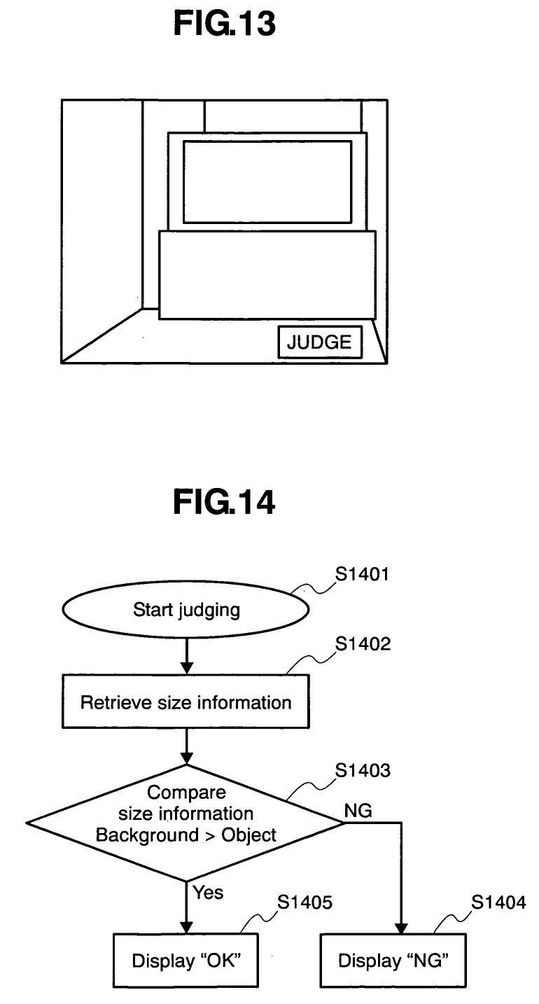

When the user chooses the button “JUDGE” shown in FIG. 13 after a simulation picture is displayed on the screen of the display 5, it is determined whether the object can be placed in the placing space (S1111).

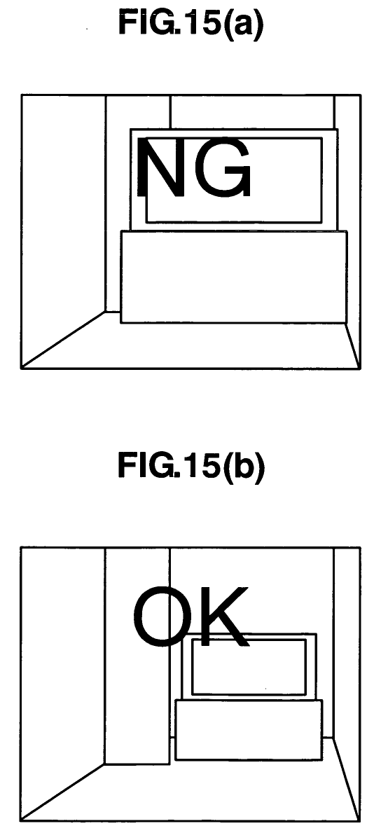

The processing of S1111 is made in accordance with, for example, the flowchart of FIG. 14. When the user chooses the button “JUDGE” (S1401), the information about the size of the placing space and the information about the size of the object are retrieved from the memory 4 (S1402) and the information about the size of the placing space and the information about the size of the object are compared (S1403). If the size of the object is larger than the size of the placing space, “NG” is displayed on the screen of the display 5 as shown in FIG. 15 (a) (S1404). If the size of the object is smaller than the size of the placing space, “OK” is displayed on the screen of the display 5 as shown in FIG. 15 (b) (S1405). The user may have difficulty in determining whether an object fits into a placing space or not by merely seeing their simulation picture. In this case, the display of “OK” or “NG” helps the user. The display of FIG. 15 is an example, and other methods of indicating whether an object fits into a placing space or not may be adopted. The indication may be made through voice etc.

If both the width and height of a placing space are defined, “OK” is displayed when the width and height of an object are smaller than the width and height of the placing space, respectively; otherwise, “NG” is displayed. In the latter case, it is desirable to indicate which is oversized, the width or the height of the object.

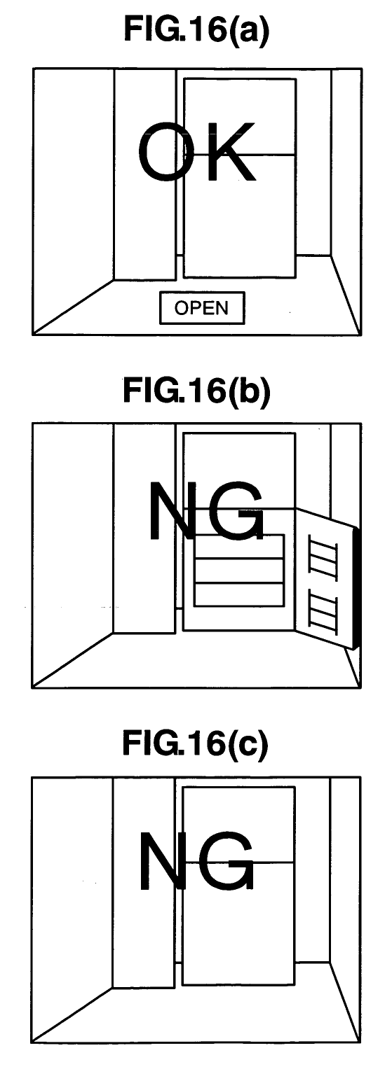

If information about the openable components, such as doors and drawers, of an object is stored as additional information into the memory 4, a button “OPEN” is displayed, for example, on the screen of the display 5 as shown in FIG. 16 (a). When the button “OPEN” is chosen, the information about the size of the object with its openable components opened is retrieved from the memory 4 and compared with the information of the size of a placing space. If the size of the object with its openable components opened is larger than the size of the placing space, “NG” is displayed on the screen of the display 5 as shown in FIG. 16 (b). As shown in FIG. 16 (c), such “NG” may be displayed while the object with its openable components closed is displayed.

Although information about pictures at the times of the setting of an object and a placing space are used as real-time pictures in the above description, there is no limitation to this. Information about sizes calculated at the times of the setting of an object and a placing space may be used, and a through picture displayed on the screen of the display 5 may be used as a real-time picture. In this case, an error of size occurs when the user moves the portable terminal 100; therefore, it is desirable to demand the resetting of the object and its position at certain time intervals.

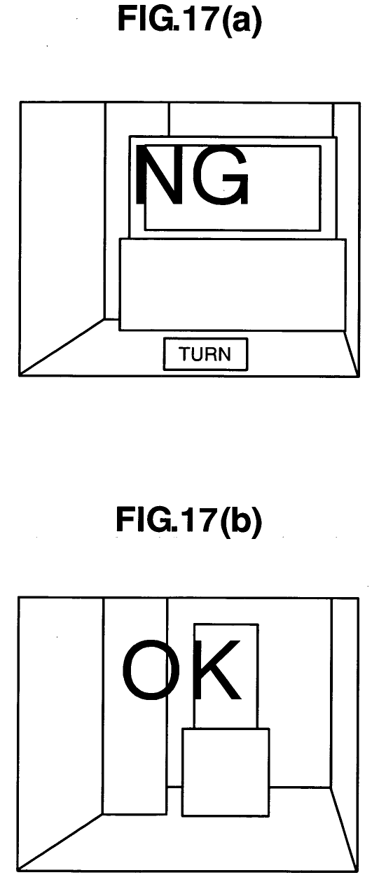

If information about the three-dimensional picture of an object is stored in the memory 4 and the information is chosen, it is indicated as shown in FIG. 17 (a) that the object can be turned. If the button “TURN” is chosen, the object is turned by 45° or 90° on the screen of the display 5 and it is again determined whether the object fits into the placing space or not. The result is displayed as shown in FIG. 17 (b). Thus, the user can see whether or not an object fits into a placing space while turning the object, and the convenience of the portable terminal 100 can be raised.

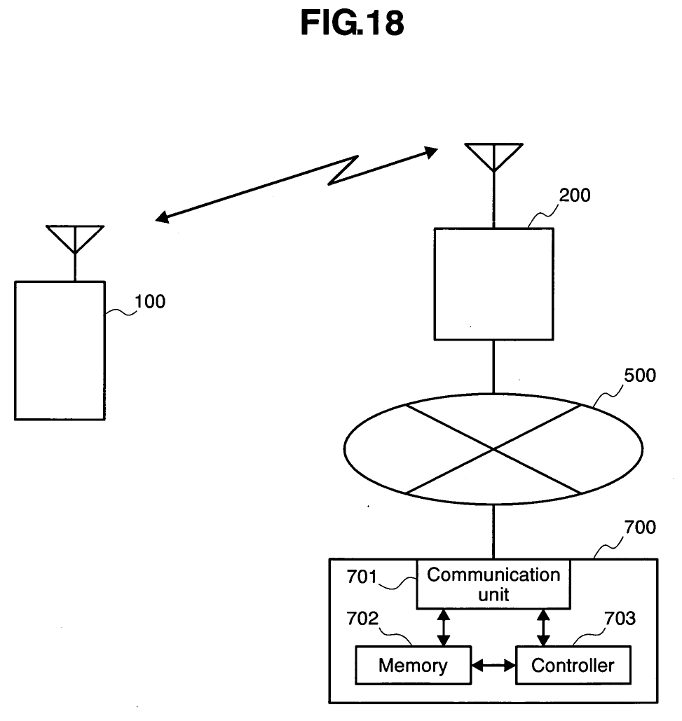

Although simulation pictures are produced by the portable terminal 100 in the above embodiment, information about pictures and sizes may be sent to an image-processing center through a network and simulation pictures may be produced at the center as shown in FIG. 18.

For example, the portable terminal 100 sends information about pictures, etc. to an image-processing center 700 through a radio base station 200 and a network 500. The image-processing center 700 receives the information through its communication unit 701 and stores the information in its memory 702. The controller 703 enlarges/reduces the received object and background pictures to make the relative sizes of the object and background even and combines them into a virtual picture. The image-processing center 700 sends the produced virtual picture to the portable terminal 100. The portable terminal 100 can present a desired virtual picture to the user by showing the received virtual picture on the display 5. In the example shown in FIG. 18, the size information is sent together with the picture information. However, the picture information alone may be sent from the portable terminal 100 and the size information may be produced at the image-processing center.

According to the embodiments described above, the portable terminal and information-processing device, and system whose usability is improved can be provided.

The foregoing invention has been described in terms of preferred embodiments. However, those skilled, in the art will recognize that many variations of such embodiments exist. Such variations are intended to be within the scope of the present invention and the appended claims.

What is claimed is:

1. A portable terminal, comprising:
an imaging unit outputting picture information;
a display capable of receiving the picture information outputted from the imaging unit and showing a picture;
a first designating unit designating a placing space where an object is placed in the picture shown on the display;
a first picture-producing unit receiving the picture outputted from the imaging unit and producing first picture information including the placing space designated by the first designating unit;
a second designating unit designating an object to be extracted from the picture shown on the display;
a second picture-producing unit receiving the picture outputted from the imaging unit and producing second picture information wherein a picture of the object designated by the second designating unit is extracted from the picture;
an enlarging/reducing processor enlarging or reducing the second picture information according to first size information showing the size of the placing space and second size information showing the size of the object designated by the second designating unit;
a picture-combining processor outputting a simulation picture made by combining the first picture information and the second picture information enlarged or reduced by the enlarging/reducing processor to the display; and
a notifying unit notifying whether or not the object designated by the second designating unit can be placed in the placing space.

2. A portable terminal according to claim 1, further comprising a memory in which the first picture information and the first size information are stored while the latter being associated with the former.

3. A portable terminal according to claim 1, further comprising:
a first size-acquiring unit acquiring the first size information; and
a second size-acquiring unit acquiring the second size information.

4. A portable terminal comprising:
an imaging unit outputting picture information;
a display capable of receiving the picture information outputted from the imaging unit and showing a picture;
a first designating unit designating a placing space where an object is placed in the picture shown on the display;
a first size-acquiring unit acquiring first size information showing the size of the placing space;
a second designating unit designating an object to be extracted from the picture shown on the display;
a second size-acquiring unit acquiring second size information showing the size of the object designated by the second designating unit; and
a notifying unit notifying whether or not the object designated by the second designating unit can be placed in the placing space.

5. A portable terminal according to claim 1, further comprising a comparing unit comparing the first size information with the second size information.

6. An information-processing device comprising:
a first choosing unit choosing a placing space where an object is to be placed;
a first size-acquiring unit acquiring first size information showing the size of the placing space chosen by the first choosing unit;
a second choosing unit choosing an object to be placed;
a second size acquiring unit acquiring second size information showing the size of the object chosen by the second choosing unit; and
a notifying unit notifying whether or not the object chosen by the second choosing unit can be placed in the placing space.

7. An information-processing device according to claim 6, further comprising a comparing unit comparing the first size information with the second size information.

8. A system for producing a simulation picture comprising:
a portable terminal; and
a picture-processing center capable of sending and receiving data to and from the portable terminal,
wherein the portable terminal comprises an imaging unit outputting picture information; a first designating unit designating a placing space where an object is placed; a first picture-producing unit producing first picture information including the placing space designated by the first designating unit by using the picture information outputted from the imaging unit; a second designating unit designating an object to be placed; a second picture-producing unit producing second picture information by extracting a picture of the object designated by the second designating unit from the picture information outputted from the imaging unit; a first transmitting unit sending the first and second picture information to the picture-processing center; and a first receiving unit receiving picture information sent from the picture-processing center, and
wherein the picture-processing center comprises a second receiving unit receiving the first and second picture information sent from the portable terminal; an enlarging/reducing unit enlarging or reducing the second picture information according to first size information showing the size of the placing space and second size information showing the size of the object designated by the second designating unit; a picture-combining unit producing a simulation picture by combining the first picture information and the second picture information enlarged or reduced by the enlarging/reducing unit; and a second transmitting unit sending the simulation picture combined by the picture-combining unit.
